(19) United States
(12) Patent Application Publication
(10) Pub. No.: US 2002/0051543 A1
(43) Pub. Date: May 2, 2002

(54) Fast irreducibility and subgroup membership testing in XTR

(76) Inventors: Arjen K. Lenstra, Mendham, NJ (US); Eric R. Verheul, Eindhoven (NL)

Correspondence Address: MORGAN & FINNEGAN, L.L.P., 345 Park Avenue, New York, NY, 10154-0053, US

(21) Appl. No.: 09/956,883

(22) Filed: Sep. 21, 2001

Related U.S. Application Data
(60) Provisional application No. 60/234,235, filed on Sep. 21, 2000.

(51) Int. Cl. H04L 9/00

(52) U.S. Cl. 380/277; 380/30

(57) ABSTRACT

A method, system, and computer program product initializes a cryptosystem that implements XTR by reformulating an irreducibility test of a polynomial of the form F(c,X)=X³−cX²+c^{p}X−1εGF(p²)[X], for random cεGF(p²), as an irreducibility problem for a third-degree polynomial of the form P(c,X)=X³+(c^{p}+c)X²+(c^{p+1}+c^{p}+c−3)X+c^{2p}+c²+2−2c^{p}−2c, and testing the third-degree polynomial for irreducibility over GF(p). Testing the third-degree polynomial comprises eliminating the coefficient of X² from P(c,X) to generate the polynomial P(c,X−(c^{p}+c)/3)=X³+ƒ₁X+ƒ₀, and computing a discriminant Δ=ƒ₀²+4ƒ₁³/27εGF(p) by considering a polynomial of the form X²+ƒ₀X−(ƒ₁/3)³. If the discriminant Δ is not a quadratic residue in GF(p), a trace over GF(p) of r₁^{p-1} as

$$s = 2 \frac{{f}_{0}^{2} + Δ}{{f}_{0}^{2} - Δ} ,$$

wherein r₁=−ƒ₀/2+\sqrt{Δ}/2, and atrace z over GF(p) of (r₁^{p-1})^{(p+1)/3} is computed. If the trace z is not 2, P(c,X) is irreducible over GF(p).

### CROSS-REFERENCE TO RELATED APPLICATIONS

This application hereby incorporates by reference the provisional application for letters patent, Ser. No. 60/234,235, titled “Fast Irreducibility Testing for XTR”, and filed Sep. 21, 2000. The present application for letters patent is related to and incorporates by reference U.S. patent application Ser. No. 09/498,716 titled “Efficient and Compact Subgroup Trace Representation (‘XTR’)” and filed in the United States Patent and Trademark Office on Feb. 7, 2000. The present application also is related to and incorporates by reference U.S. continuation-in-part patent application Ser. No. 09/573,153 titled “Efficient and Compact Subgroup Trace Representation (‘XTR’)” and filed in the United States Patent and Trademark Office on May 19, 2000. The present application also is related to and incorporates by reference U.S. patent application Ser. No. 08/800,669 titled “Cyclotomic Polynomial Construction of Discrete Logarithm Cryptosystems over Finite Fields” and filed in the United States Patent and Trademark Office on Feb. 14, 1997. The present application also is related to and incorporates by reference U.S. patent application Ser. No. 09/057,176 titled “Generating RSA Moduli Including a Predetermined Portion” and filed in the United States Patent and Trademark Office on Apr. 8, 1998.

### FIELD OF THE INVENTION

An improved system, method, and computer program product for performing public key cryptography is disclosed. In particular, the system, method, and computer program product improves the efficiency of the polynomial irreducibility test and the subgroup membership test in an XTR system.

### BACKGROUND OF THE INVENTION

A group is a mathematical structure comprising a set of numbers and a custom-defined arithmetic operation. A non-empty set of numbers G is a group if G is closed under the binary multiplication operator (i.e., for any g and h in G, the result of g*h is also in G) and the binary multiplication operator is associative (i.e., for any a, b, and c in G, a*(b*c)=(a*b)*c). Furthermore, the group G must contain an identity element e and an inverse element h such that for any g in G, g*e=e*g=g and g*h=h*g=e.

A group is abelian if the arithmetic operation defined for the group is commutative. Thus, for any a and b, an additive group is abelian if a+b=b+a and a multiplicative group is abelianif a*b=b*a.

A field is a mathematical structure comprising a set of numbers and two custom-defined arithmetic operations, typically multiplication and addition. A non-empty set of numbers F is a field if F is closed under two binary operators, typically addition and multiplication (i.e., for any ƒ and h in F, the result of ƒ+h and ƒ*h is also in F), and F forms a commutative group with respect to the addition operator. In addition, F−{0} forms a commutative group with respect to the multiplication operator and the multiplication operator is distributive over the addition operator (i.e., a*(b+c)=a*b+a*c). Thus, the elements of the field are an additive abelian group and the non-zero elements of the field are a multiplicative abelian group. This means that all elements of the field have an additive inverse and all non-zero elements have a multiplicative inverse. Finally, the field is finite if it has a finite number of elements.

Implementation of the rules associated with group and field arithmetic is one source of the computationally intensive problems that require a solution necessary to maintain cryptographic security in a general-purpose computer system. Typically, cryptography and cryptosystems are concerned with two integer groups, Zₙ and Zₚ*, and two finite fields, Fₚ and F₂_{^{m}}.

The group Zₙ is an additive group of integers that defines addition as the basic arithmetic operation for the group and relies upon modular arithmetic with n to reduce the result to an integer in the range 0 . . . n−1. For example, the additive group Z₁₅ produces an integer result between 0 and 14 and includes calculations such as (10+12)mod15=22mod15=7 and (4+11)mod15=15mod15=0.

The group Zₚ* is a multiplicative group of integers that defines multiplication as the basic arithmetic operation for the group and relies upon modular arithmetic with p to reduce the result to an integer in the range 0 . . . p−1, where p is a prime number. For example, the multiplicative group Z₁₁* produces an integer result between 0 and 10 and includes calculations such as (4*7)mod11=28mod11=6 and (9*5)mod11=45mod11=1. The cryptosystems that implement Zₚ* include the Diffie-Hellman Key Agreement Protocol and the Digital Signature Algorithm.

The field Fₚ is a finite field that defines addition and multiplication arithmetic operations similar to the groups Zₙ and Zₚ* . The restriction thatp is a prime number is necessary so that all non-zero elements have a multiplicative inverse. As with Zₙ and Zₚ*, other operations in Fₚ, such as division, subtraction, and exponentiation, derive from the definitions of addition and multiplication. For example, calculations in the finite field F₂₃ include:

((10*4)−11)mod23=29mod23=6;

7^{-1mod}23=10 because (7*10)mod23=70mod23=1; and

8³÷7mod23=512÷7mod23=6*7⁻¹mod23=6*10mod23=14.

The field F₂_{^{m}} is a finite field of m integer results in the range 0 . . . 1. Thus, F₂_{^{m}} is extremely useful in a general-purpose computer system because calculations can be performed efficiently when implemented in either hardware or software. A field representation defines the bit-pattems that represent the various field elements. The representation, and the field, is chosen to make the field arithmetic operations efficient. For F₂_{^{m}}, two practical field representations include polynomial or normal basis.

Using a polynomial basis as the field representation, each element of F₂_{^{m}} is a polynomial of degree less than m with coefficients in F₂ (i.e., aₘ₋₁x^{m-1}+aₘ₋₂x^{m-2}+. . . +a₂x²+a₁x+a₀, where the 2^{m} elements can also be written as the vector (aₘ₋₁ . . . a₁a₀)). The main arithmetic operations in F₂_{^{m}} are addition and multiplication. Since some computations involve an inversion modulo minimal polynomial (i.e., ƒ(x)=x^{m}+ƒₘ₋₁x^{m-1}+ƒₘ₋₂x^{m-2}+ . . . +ƒ₂x²+ƒ₁x+ƒ₀, whereƒᵢ is in F₂ ), the minimal polynomial, here f (x) , must be irreducible, that is, not factorable into two polynomials over F_{2,} where each are of a degree less than m.

Using a normal basis as the field representation for F₂_{^{m}}, ƒ(x) =ƒₘ(x) is computed using the following recursive formulae:

ƒ₀(x)=1

ƒ₁(x)=x+1

ƒᵢ₊₁(x)=xƒᵢ(x)+ƒᵢ₋₁(x),i=1 . . . m

At each stage, the coefficients of the polynomials ƒᵢ(x) are reduced by modular arithmetic with the integer 2. Hence, ƒ(x) is a polynomial of degree m with coefficients in F₂. The set of polynomials {x,x²,x²^{²}, . . . , x²^{^{m-1}}} forms a basis of F₂_{^{m}} over F₂ and is called a normal basis. Next, an m by m matrix A is constructed wherein, for i=0 . . . m−1, the i^{th} row is the bit string corresponding to the polynomial x^{2′} mod f(x). Each entry of A is an element of F₂. Next, the m by m matrix T′ is constructed wherein, for i=0 . . . m−1, the i^{th} row is the bit string corresponding to xx^{2′} mod ƒ(x). Then, the matrix T=T′A⁻¹ over F₂ is constructed wherein A⁻¹ is the inverse matrix of A over F₂. Finally, the product terms Iᵢⱼ, for i,j=0 . . . m−1, as Iᵢⱼ=T(j−i,−i) is determined wherein T(g,h) denotes the (g,h)-entry of T with indices reduced by modular arithmetic with the integer m. Each product term Iᵢⱼ is an element of F₂. It should also be the case that I₀ⱼ=1 for precisely one j, 0≦j≦m−1, and that for each i, 0≦i≦m−1, Iᵢⱼ=1 for precisely two distinct j, 0≦j≦m−1. Hence, only 2m−1 of the m² entries of the matrix T are 1, with the remaining entries being 0. This scarcity of 1 bits is the reason that the normal basis is called an optimal normal basis.

The Diffie-Hellman key agreement protocol was the first published practical solution to the key distribution problem, allowing two parties that have never met to establish a shared secret key by exchanging information over an open channel. In the basic Diffie-Hellman scheme, the two parties agree upon a generator g of the multiplicative group GF(p)* of a prime field GF(p) and they each send a random power of g to the other party. Assuming both parties know p and g, each party transmits about log₂ (p) bits to the other party.

The prior art suggests the use of finite extension fields instead of prime fields, but does not imply any direct computational or communication advantages. The prior art also suggests a variant of the basic Diffie-Hellman scheme in which g generates a relatively small subgroup of GF(p)* of prime order q. This considerably reduces the computational cost of the Diffie-Hellman scheme, but has no effect on the number of bits to be exchanged. Finally, the prior art demonstrates how the use of finite extension fields and subgroups can be combined in such a way that the number of bits to be exchanged is reduced by a factor of 3. More specifically, the prior art shows that conjugates of elements of a subgroup of GF(p⁶)* of an order dividing φ₆(p)=p²−p+1 can be represented using 2log₂(p) bits, as opposed to the 6log₂ (p) bits that would be required for a traditional representation. Even though the method increases communication efficiency, it is cumbersome and not particularly computationally efficient.

Efficient Compact Subgroup Trace Representation (ECSTR), or phonetically “XTR”, is an improvement to the prior art discussed herein that achieves the same communication advantage at a much lower computational cost. XTR is a public key cryptosystem that performs encryption-decryption, signature generation, signature verification, and key agreement and can be used in conjunction with any cryptographic protocol that is based on the use of subgroups. XTR achieves the same communication advantage as the prior art, but yields a much lower computational cost. The reduced communication requirements, and significant computation advantages indicate that XTR could be suitable for the ever-smaller computing devices encountered daily. Some common applications that are well-suited to XTR include the Wireless Application Protocol (WAP), Secure Sockets Layer (SSL), and smart cards.

XTR is an excellent alternative to either the Rivest, Shamir, and Adelman (RSA) public key encryption technique or Elliptic Curve Cryptosystems (ECC) using random curves over prime fields because it combines most of the advantages of RSA and ECC without any of the disadvantages. More specifically, with the exception of signature applications, XTR keys are much smaller than RSA keys of equivalent security, and at most twice as big as ECC keys. Furthermore, parameter and key selection for XTR is very fast compared to RSA, and thus much faster than ECC. Finally, for almost any cryptographic application, XTR is faster than ECC when random curves over prime fields are used, with the exception of signature verification where ECC is slightly faster than XTR.

A previous improvement to XTR modified the method to solve cubic equations and was able to reduce the XTR public key size for signature applications by a factor of 3 if the field characteristic was not equal to 8 mod 9. As a side result, the improved XTR method to find the trace of a proper subgroup generator is 50% faster. Finally, the improved XTR uses a faster deterministic method for the same problem that works only if the characteristic is not equal to 8 mod 9.

Thus, there is a need for an improved system, method, and computer program product for initializing an XTR system and determining the trace generator of an XTR group. Specifically, the improved system, method, and computer program product improves the efficiency of the polynomial irreducibility test performed during the XTR parameter set-up process. In addition, the improved set-up process also reduces the time required to test subgroup membership when using XTR. The system, method, and computer program product disclosed herein addresses this need.

### SUMMARY OF THE INVENTION

A method, system, and computer program product of parameter setup in a cryptosystem that implements XTR is disclosed. The method, system, and computer program product comprises finding a trace of a generator of a group, and initializing the cryptosystem with the trace. The method, system, and computer program product can also include testing a subgroup membership with the cryptosystem.

A second embodiment of the method, system, and computer program product reformulates a polynomial to another form that can be more efficiently tested for irreducibility. The first step includes reformulating an irreducibility test of a polynomial of the form F(c,X)=X³−cX²+c^{p}X−1εGF(p²)[X], for random cεGF(p²), as an irreducibility problem for a third-degree polynomial of the form P(c,X)=X³+(c^{p}+c)X²+(c^{p+1}+c^{p}+c−3)X+c^{2p}+c²+2−2c^{p}−2c. Following the reformulation, the second step include testing the third-degree polynomial of the form P(c,X)=X³+(c^{p+c)X}²+(c^{p+1}+c^{p}+c−3)X+c^{2p}+c²+2−2c^{p}2c for irreducibility over GF(p).

In the second embodiment, the testing of the third-degree polynomial of the form P(c,X)=X³+(c^{p}+c)X²+(c^{p+1}+c^{p}+c−3)X+C^{2p}+c²+2−2c^{p}−2c for irreducibility over GF(p) comprises eliminating the coefficient of X² from P(c,X) by substituting X−(c^{p}+c)/3 for X and generating the polynomial P(c,X−(c^{p}+c)/3)=X³+ƒ₁X+ƒ₀, and computing a discriminant Δ=ƒ₀²+4ƒ₁³/27εGF(p) by considering a polynomial of the form X²+ƒ₀X−(ƒ₁/3)³. If the discriminant Δ is a quadratic residue in GF(p), P(c,X) is not irreducible over GF(p). If the discriminant Δ is not a quadratic residue in GF(p), the method, system, and computer program product further comprises computing a trace over GF(p) of r₁^{p-1} as

$$s = 2 \frac{{f}_{0}^{2} + Δ}{{f}_{0}^{2} - Δ} ,$$

wherein r₁=−ƒ₀/2+∞\sqrt{Δ}/2, and computing a trace z over GF(p) of (r₁^{p-1})^{(p+1)/3}. If the trace z is 2, P(c,X) is not irreducible over GF(p). If the trace z is not 2, P(c,X) is irreducible over GF(p).

The second embodiment of the method, system, and computer program product further includes preventing a subgroup attack on the cryptosystem. The preventing of the subgroup attack can also include verifying the consistency of an XTR signature public key presented by a client before issuing a certificate to prevent the subgroup attack on the cryptosystem.

### BRIEF DESCRIPTION OF THE DRAWINGS

The accompanying figures best illustrate the details of the improved system, method, and apparatus for initializing an XTR system and determining the trace generator of an XTR group, both as to its structure and operation. Like reference numbers and designations in the accompanying figures refer to like elements.

FIG. 1 is a network diagram that depicts an operating environment for an embodiment of the improved XTR system for initializing an XTR system and determining the trace generator of an XTR group.

FIG. 2 is a functional block diagram showing the hardware and software components that comprise server 110.

FIG. 3 is a functional block diagram showing the hardware and software components that comprise client 120.

FIG. 4 is a functional block diagram showing the hardware and software components that comprise mainframe 130.

FIG. 5 is a functional block diagram showing the hardware and software components that comprise mobile device 144.

FIG. 6 is a flow diagram of the method of parameter setup in a cryptosystem that implements XTR.

FIG. 7 is a flow diagram that describes, in greater detail, step 620 from the method shown in FIG. 6 for testing the polynomial P(c,X) for irreducibility.

### DETAILED DESCRIPTION OF THE INVENTION

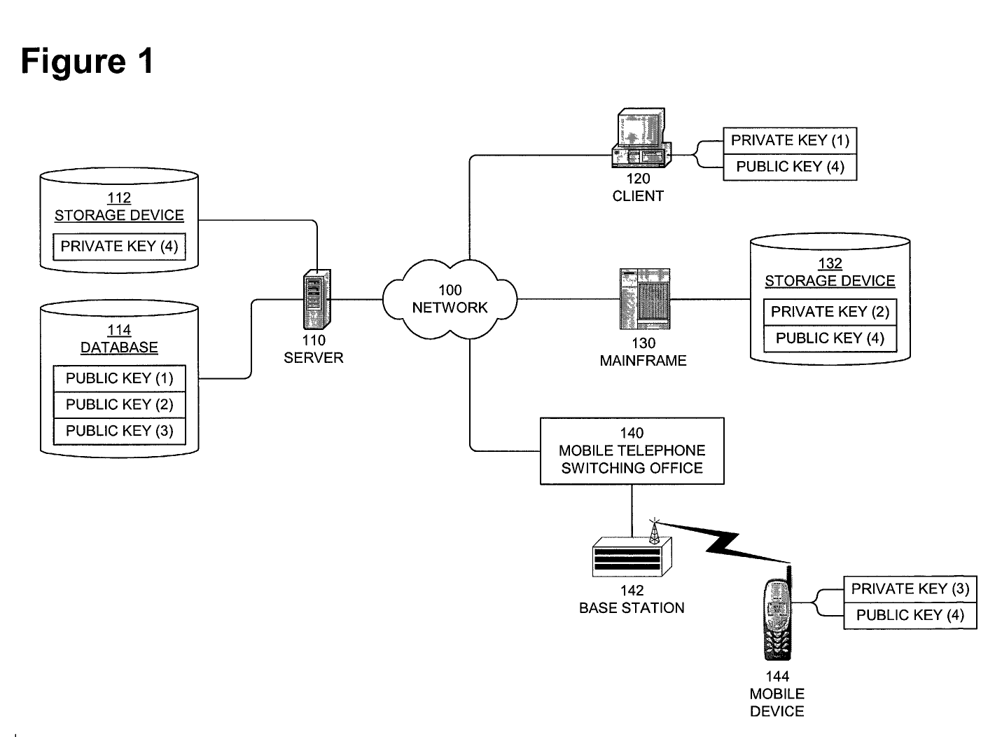

FIG. 1 is a network diagram that depicts an operating environment for an embodiment of the improved XTR system for initializing an XTR system and determining the trace generator of an XTR group. Network 100, a public communication network, connects and enables data transfer between server 110, client 120, mainframe 130, and mobile telephone switching office 140.

Even though the embodiment depicted in FIG. 1 includes a public communication network, the improved XTR system contemplates the use of public or private network architectures such as an intranet or extranet. An intranet is a private communication network that functions similar to Network 100. An organization such as a corporation creates an intranet to provide a secure means for members of the organization to access the resources on the organization's network. An extranet is also a private communication network that functions similar to Network 100. In contrast to an intranet, an extranet provides a secure means for the organization to authorize non-members of the organization to access certain resources on the organization's network. The improved XTR system also contemplates using a network protocol, such as Ethernet or Token Ring, as well as proprietary network protocols.

Referring again to FIG. 1, server 110 also connects to storage device 112 and database 114. Mainframe 130 connects to storage device 132. Mobile telephone switching office 140 connects to base station 142. Base station 142 uses a wireless communication protocol such as radio frequency, wireless access protocol (WAP), or Bluetooth to connect to mobile device 144. In another embodiment, mobile device 144 includes a cellular telephone, a satellite telephone, or a personal digital assistant (PDA).

As shown in FIG. 1, server 110, client 120, mainframe 130, and mobile device 140 can perform the method of the invention. Client 120 generates, in accordance with the method of the invention, private key (1) and public key (1). Client 120 stores private key (1) in internal memory (not shown) and transmits public key (1) over network 100 to server 110 for storage in database 114. Mainframe 130 generates, in accordance with the method of the invention, private key (2) and public key (2). Mainframe 130 stores private key (2) in storage device 132 and transmits public key (2) over network 100 to server 110 for storage in database 114. Mobile device 144 generates, in accordance with the method of the invention, private key (3) and public key (3). Mobile device 144 stores private key (3) in internal memory (not shown) and transmits public key (3) via base station 142, mobile telephone switching office 140, and network 100 to server 110 for storage in database 114. Server 110 generates, in accordance with the method of the invention, private key (4) and public key (4). Server 110 stores private key (4) in storage device 112 and transmits public key (4) over network 100 to client 120 for storage in storage device 122 and to mainframe 130 for storage in storage device 132. Server 110 also transmits public key (4) via mobile telephone switching office 140 and base station 142 for storage in internal memory (not shown) associated with mobile device 144. All public keys are properly certified using standard key certification methods as can be found in the cryptographic literature, such as the Handbook of Applied Cryptography, by A. J. Menezes, P. C. van Oorschot, and S. A. Vanstone, CRC Press, 1997.

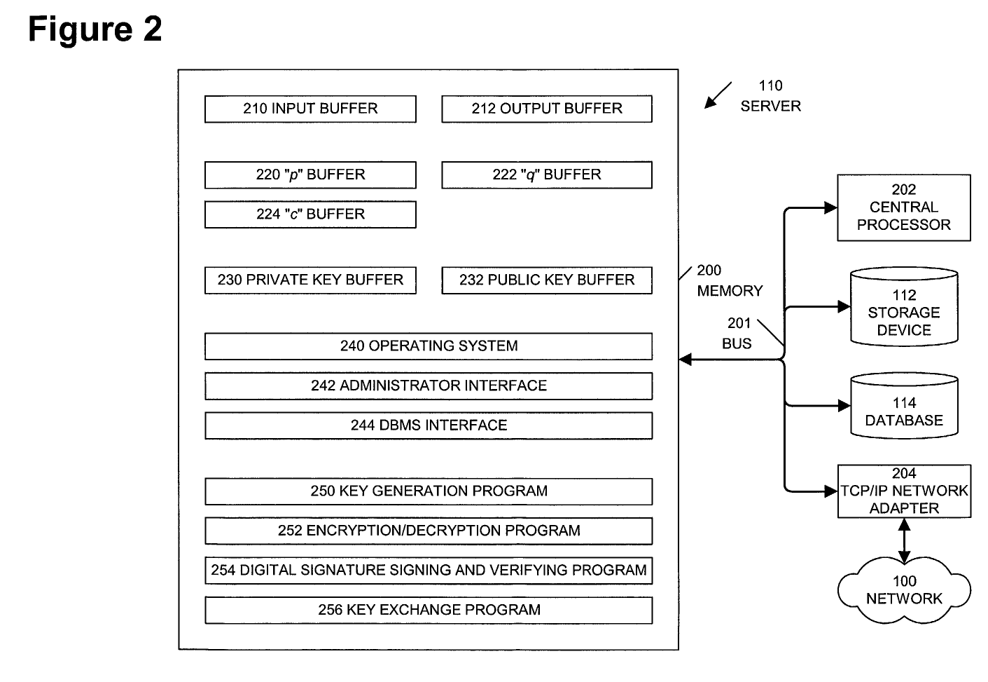

FIG. 2 is a functional block diagram showing the hardware and software components that comprise server 110. Bus 201 connects central processor 202, storage device 112, database 114, and transmission control protocol/internet protocol (“TCP/IP”) network adapter 204 to memory 200. TCP/IP network adapter 204 also connects to network 100 and facilitates the passage of network traffic between server 110 and network 100. Central processor 202 performs the methods disclosed herein by executing the sequences of operational instructions that comprise each computer program resident in, or operative on, memory 200.

As shown in FIG. 2, memory 200 includes buffers for storing intermediate and final data calculations associated with the algorithms disclosed herein. Memory 200 includes input buffer 210, output buffer 212, “p” buffer 220, “q” buffer 222, “c” buffer 224, private key buffer 230, and public key buffer 232. Sections 2, 3, 4, and 5, below, disclose the calculations and algorithms involving the values for p, q, and c. Memory 200 also includes programs for controlling server 110 and performing the methods of the invention. The programs for controlling server 110 include operating system 240, administrator interface 242, and database management system (DBMS) interface 244. The programs for performing the methods of the invention include key generation program 250, encryption/decryption program 252, digital signature signing and verifying program 254, and key exchange program 256. Key generation program 250 generates, in accordance with the method of the invention, the public and private keys that allow encryption/decryption program 252 to encrypt and decrypt data. Digital signature signing and verifying program 254 uses the public and private keys to associate a digital signature with the encrypted and decrypted data. Key exchange program 256 uses the public and private keys in a Diffie-Hellman key exchange scheme.

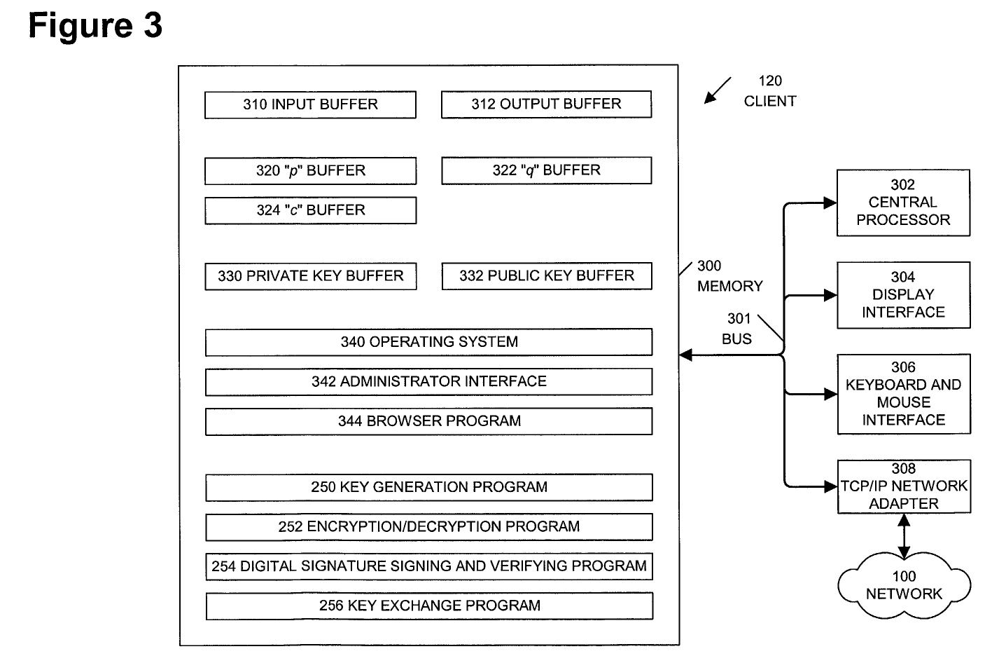

FIG. 3 is a functional block diagram showing the hardware and software components that comprise client 120. Bus 301 connects central processor 302, display interface 304, keyboard and mouse interface 306, and transmission control protocol/internet protocol (“TCP/IP”) network adapter 308 to memory 300. TCP/IP network adapter 308 also connects to network 100 and facilitates the passage of network traffic between client 120 and network 100. Central processor 302 performs the methods disclosed herein by executing the sequences of operational instructions that comprise each computer program resident in, or operative on, memory 300.

As shown in FIG. 3, memory 300 includes buffers for storing intermediate and final data calculations associated with the algorithms disclosed herein. Memory 300 includes input buffer 310, output buffer 312, “p” buffer 320, “q” buffer 322, “c” buffer 324, private key buffer 330, and public key buffer 332. Sections 2, 3, 4, and 5, below, disclose the calculations and algorithms involving the values for p, q, and c. Memory 300 also includes programs for controlling client 120 and performing the methods of the invention. The programs for controlling client 120 include operating system 340, administrator interface 342, and browser program 344. Browser program 344 includes any program that communicates with a server computer via network 100 to receive and display information in a structured generalized markup language such as hypertext markup language or extensible markup language, and to transmit information in response to a specific question. The programs for performing the methods of the invention include key generation program 250, encryption/decryption program 252, digital signature signing and verifying program 254, and key exchange program 256. Key generation program 250 generates, in accordance with the method of the invention, the public and private keys that allow encryption/decryption program 252 to encrypt and decrypt data. Digital signature signing and verifying program 254 uses the public and private keys to associate a digital signature with the encrypted and decrypted data. Key exchange program 256 uses the public and private keys in a Diffie-Hellman key exchange scheme.

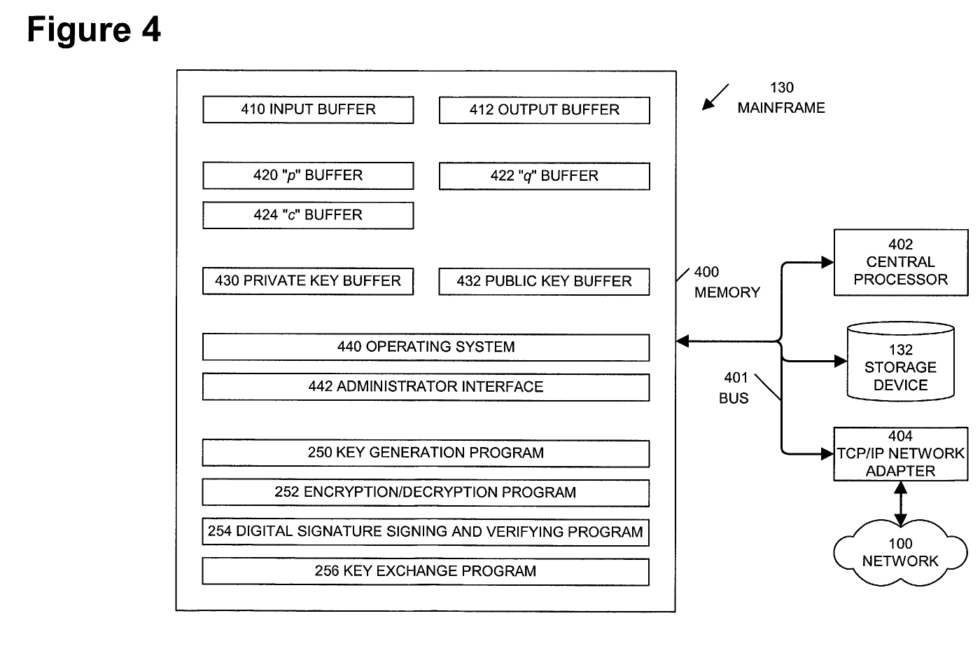

FIG. 4 is a functional block diagram showing the hardware and software components that comprise mainframe 130. Bus 401 connects central processor 402, storage device 132, and transmission control protocol/internet protocol (“TCP/IP”) network adapter 404 to memory 400. TCP/IP network adapter 404 also connects to network 100 and facilitates the passage of network traffic between mainframe 130 and network 100. Central processor 402 performs the methods disclosed herein by executing the sequences of operational instructions that comprise each computer program resident in, or operative on, memory 400.

As shown in FIG. 4, memory 400 includes buffers for storing intermediate and final data calculations associated with the algorithms disclosed herein. Memory 400 includes input buffer 410, output buffer 412, “p” buffer 420, “q” buffer 422, “c” buffer 424, private key buffer 430, and public key buffer 432. Sections 2, 3, 4, and 5, below, disclose the calculations and algorithms involving the values for p, q, and c. Memory 400 also includes programs for controlling mainframe 130 and performing the methods of the invention. The programs for controlling mainframe 130 include operating system 440 and administrator interface 442. The programs for performing the methods of the invention include key generation program 250, encryption/decryption program 252, digital signature signing and verifying program 254, and key exchange program 256. Key generation program 250 generates, in accordance with the method of the invention, the public and private keys that allow encryption/decryption program 252 to encrypt and decrypt data. Digital signature signing and verifying program 254 uses the public and private keys to associate a digital signature with the encrypted and decrypted data. Key exchange program 256 uses the public and private keys in a Diffie-Hellman key exchange scheme.

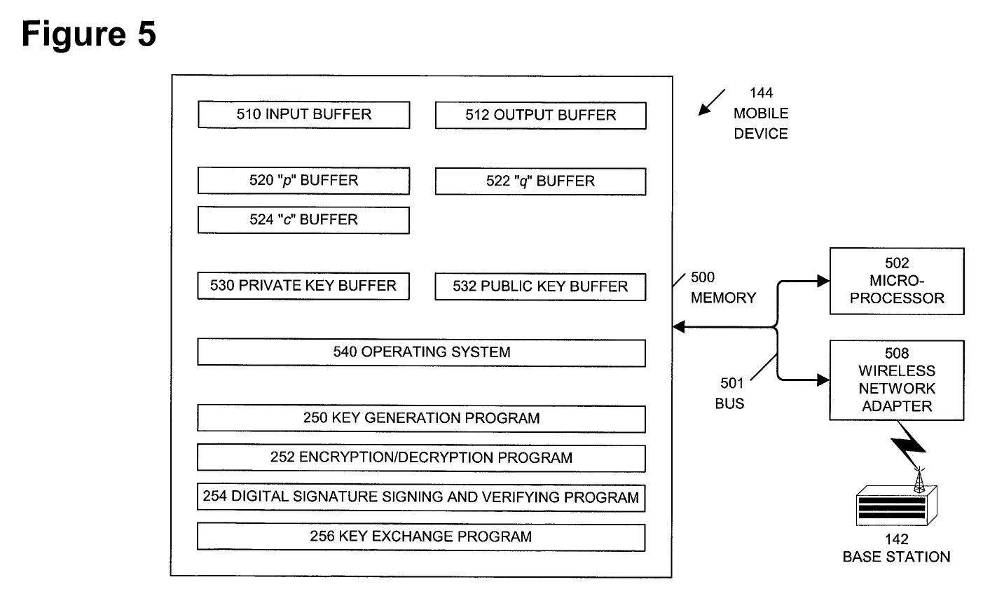

FIG. 5 is a functional block diagram showing the hardware and software components that comprise mobile device 144. Bus 501 connects microprocessor 502 and wireless network adapter 508 to memory 500. Wireless network adapter 508 also connects to base station 142 and facilitates the passage of network traffic between mobile device 144, mobile telephone switching office 140, and network 100. Microprocessor 502 performs the methods disclosed herein by executing the sequences of operational instructions that comprise each computer program resident in, or operative on, memory 500.

As shown in FIG. 5, memory 500 includes buffers for storing intermediate and final data calculations associated with the algorithms disclosed herein. Memory 500 includes input buffer 510, output buffer 512, “p” buffer 520, “q” buffer 522, “c” buffer 524, private key buffer 530, and public key buffer 532. Sections 2, 3, 4, and 5, below, disclose the calculations and algorithms involving the values for p, q, and c. Memory 500 also includes programs for controlling mobile device 144 and performing the methods of the invention. The programs for controlling mobile device 144 include operating system 540. The programs for performing the methods of the invention include key generation program 250, encryption/decryption program 252, digital signature signing and verifying program 254, and key exchange program 256. Key generation program 250 generates, in accordance with the method of the invention, the public and private keys that allow encryption/decryption program 252 to encrypt and decrypt data. Digital signature signing and verifying program 254 uses the public and private keys to associate a digital signature with the encrypted and decrypted data. Key exchange program 256 uses the public and private keys in a Diffie-Hellman key exchange scheme.

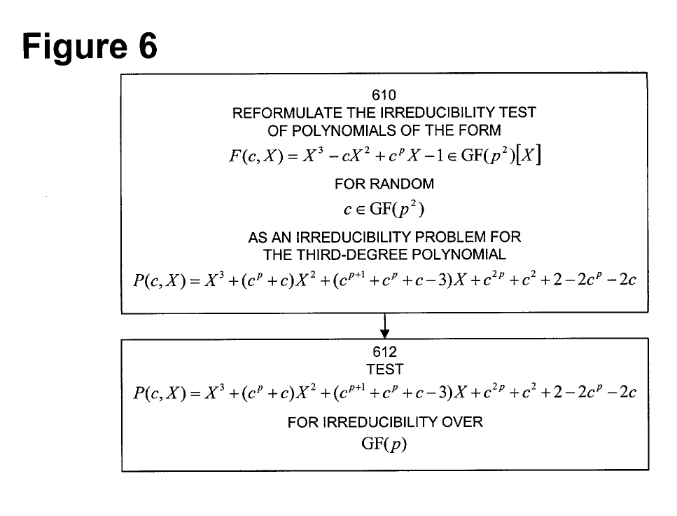

FIG. 6 is a flow diagram of the method of parameter setup in a cryptosystem that implements XTR. Server 110, client 120, mainframe 130, and mobile device 144 can perform, in accordance with the invention, the method disclosed in FIG. 6. The method begins at step 610 by reformulating the irreducibility test of polynomials of the form F(c,X)=X³−cX²+c^{p}X−1εGF(p²)[X], for random cεGF(p²), as an irreducibility problem for the third-degree polynomial P(c,X)=X³+(c^{p}+c)X²+(c^{p+1}+c^{p}+c−3)X+c^{2p}+c²+2−2c^{p}−2c. The method completes at step 612 by testing P(c,X)=X³+(c^{p}+c)X²+(c^{p+1}+c^{p}+c−3)X+c^{2p}+c²+2−2c^{p}−2c for irreducibility over GF(p).

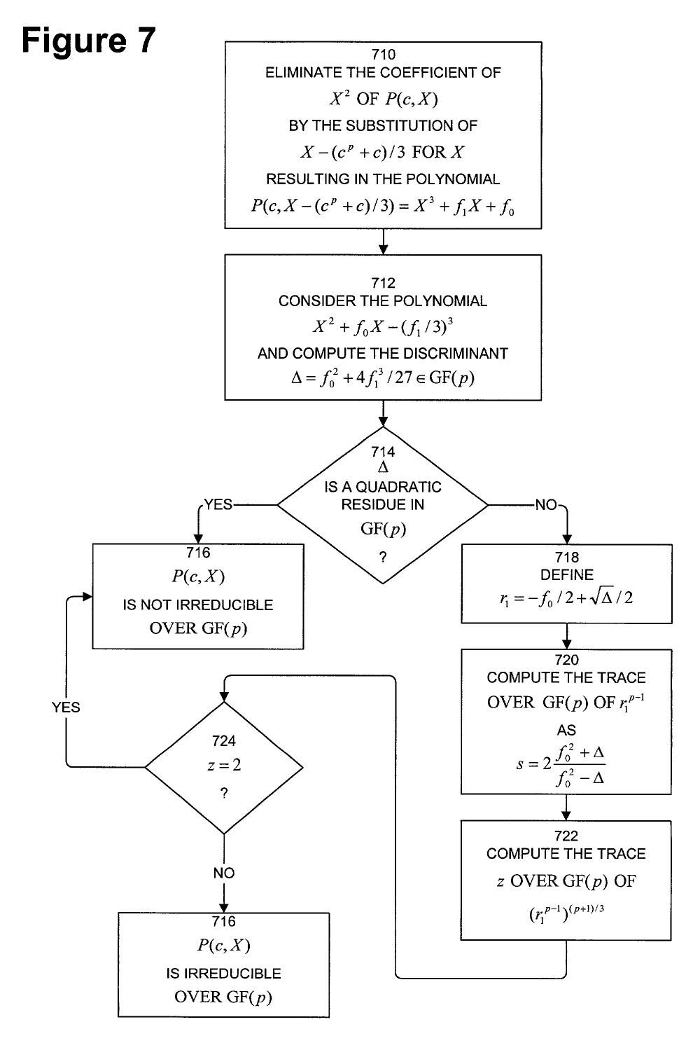

FIG. 7 is a flow diagram that describes, in greater detail, step 620 from the method shown in FIG. 6 for testing the polynomial P(c,X) for irreducibility. Server 110, client 120, mainframe 130, and mobile device 144 can perform, in accordance with the invention, the method disclosed in FIG. 7. The method begins at step 710 by eliminating the coefficient of X² of P(c,X) by the substitution of X−(c^{p}+c)/3 for X in P(c,X−(c^{p}+c)/3)=X³+ƒ₁X+ƒ₀. The method proceeds to step 712 by considering the polynomial X²+ƒ₀X−(ƒ₁/3)³ and computing the discriminant Δ=ƒ₀²+4ƒ₁³/27εGF(p). At step 714, the method examines the value of Δ. If Δ is a quadratic residue in GF(p), P(c,X) is not irreducible over GF(p). If Δ is not a quadratic residue in GF(p), the method proceeds to step 718 by defining r₁=−ƒ₀/2+∞\sqrt{Δ}/2. Next, at step 720, the method computes the trace over GF(p) of r₁^{p-1} as

$$s = 2 \frac{{f}_{0}^{2} + Δ}{{f}_{0}^{2} - Δ} .$$

At step 722, the method computes the trace z over GF(p) of (r₁^{p-1})^{(p+1)/3}. The method completes at step 724 by examining the value of z. If the value of z is 2, P(c,X) is not irreducible over GF(p). If the value of z is not 2, P(c,X) is irreducible over GF(p).

1. Introduction

XTR is an efficient and compact method to work with order p2−p+1 subgroups of the multiplicative group GF(p⁶)* of the finite field GF(p⁶). It was introduced at Crypto 2000 (cf. [4]), followed by several practical improvements at Asiacrypt 2000 (cf. [5]). In this paper we present some further improvements of the methods from [4] and [5]. Given the rapidly growing interest in XTR our new methods are of immediate practical importance.

Let p and q be primes such that p=2 mod 3 and q divides p²−p+1 let g be a generator of the order q subgroup of GF(p⁶)* , and let Tr(g)=g+g^{p}^{²}+g^{p}^{⁴} εGF(p² ) be the trace over GF(p²) of g. In [4] it is shown that the conjugates over GF(p²) of elements of the XTR group (g) can conveniently be represented by their trace over GF(p²), and it is shown how this representation can efficiently be computed given Tr(g).

Given p and q the trace of a generator of the XTR group can be found as follows, as shown in [4]. First one finds a value cεGF(p²) such that F(c,X)=X³−cX²+c^{p}X−1εGF(p²)[X] is irreducible over GF(p²) . Given an irreducible F(c,X), there exists an element hεGF(p⁶)* of order >3 and dividing p²−p+1 such that Tr(h)=c. This implies that Tr(g) can be computed as Tr(h^{(p}^{²}^{-p+1)/q}), assuming that this value is ≠3; if Tr(h^{(p}^{²}^{-p+1)/q})=3 another c has be to found such that F(c,X) is irreducible. Because F(c,X) is irreducible for about one third of the c's in GF(p²), on average 3q /(q−1) different c's have to be tried before a proper c is found.

Thus, for the XTR parameter set-up process one needs to be able to test irreducibility of polynomials of the form F(c,X)=X³−cX²+c^{p}X−1εGF(p²)[X] for random cεGF(p²). The irreducibility test given in [4] takes 8log₂(p) multiplications in GF(p); finding an irreducible F(c,X) using this method thus takes an expected 24log₂(p) multiplications in GF(p). In the follow-up paper [5], a method is described that tests irreducibility of F(c,X) for random cεGF(p²) in 2.4log₂(p) multiplications in GF(p) on average, so that an irreducible F(c,X) can on average be found in 7.2log₂(p) multiplications in GF(p). In this paper we present a further refinement of this last method that results in an F(c,X)-irreducibility test that takes, on average for random cεGF(p²), only 0.9log₂(p) multiplications in GF(p). As a result, an irreducible F(c,X) can be found in an expected 2.7log₂(p) multiplications in GF(p).

The test from [4] takes 8log₂ (p) multiplications in GF(p), irrespective of the outcome of the test. The test from [5], on the other hand, is effectively free for half the c's, and takes 4.8log₂(p) multiplications in GF(p) for the other half (two thirds of which lead to an irreducible F(c,X)). Similarly, the refined test in the present paper is effectively free for half the c's, and takes 1.8log₂(p) multiplications in GF(p) for the other half. Thus, if during a cryptographic application of XTR a value c is transmitted for which, if the protocol is carried out correctly, F(c,X) is supposed to be irreducible, then the irreducibility of F(c,X) can be verified at the cost of 1.8log₂(p) multiplications in GF(p) using our new method. This is more than 60% faster than the method from [5] and implies that this verification by the recipient of XTR related values does not cause severe additional overhead. Note that such checks are required because many cryptographic protocols are vulnerable if “wrong” data are used (cf. [1], [2], [6], [11], and Section 4).

As the irreducibility test from [5] our new irreducibility test is based on Scipione del Ferro's method. Instead of applying it directly to test F(c,X)εGF(p²)[X] for irreducibility, however, we reformulate the problem as an irreducibility problem for a third-degree polynomial P(c,X)εGF(p)[X]. This is done in Section 2. We then show in Section 3 how the irreducibility of the resulting polynomial P(c,X) can be verified. In Section 4 we discuss subgroup membership testing, and in Section 5 we show how this can be done in XTR. We present a method that is based on the F(c,X)-irreducibility test and costs a small amount of additional computation but no additional communication, and another method that takes only a constant number of GF(p)-operations but causes some additional communication overhead.

2. From F(c,X)εGF(p²)[X] to P(c,X)εGF(p)[X]

Let cεGF(p²) and let hⱼ=GF(p⁶) for j=0, 1, 2 be the roots of F(c,X)εGF(p²)[X]. Because F(c,hⱼ^{-p})=0 for j=0, 1, 2 (cf. [4, Lemma 2.3.2.iv]) we can distinguish three cases:

I. hⱼ=hⱼ^{-p} for j=0, 1, 2.

II. h₀=h₀^{-p} and hⱼ=h₃₋ⱼ^{-p} for j=1, 2.

III. hⱼ=h_{j+1 mod 3}^{p31 p} for j=0,1,2.

In cases I and II we have that hⱼεGF(p²) so that F(c, X) is reducible over GF(p²). In case III all hⱼ have order dividing p²−p+1 and >3 so that F(c,X) is irreducible over GF(p²) (cf. [4, Lemma 2.3.2.vi]). Thus, if case III can quickly be distinguished from the other two cases, then the irreducibility of F(c,X) can quickly be tested. Actually, we only have to be able to distinguish between cases I and III, because case II can quickly be recognized since it applies if and only if ΔεGF(p) as in [5, Step 2 of Algorithm 3.5] is a quadratic non-residue in GF(p) (cf. [5, Lemma 3.6]).

Definition 2.1. Let G(c,X)=F(c,X)·F(c^{p},X), and let P(c,X)=X³+(c^{p}+c)X²+(C^{p+1}+c^{p}+c−3)X+c^{2p}+c²+2−2c^{p}−2c.

The following lemma describes some of the immediate properties of the polynomials G(c,X) and P(c,X) and their interrelation.

Lemma 2.2. Both G(c,X) and P(c,X) are in GF(p)[X]. Furthermore P(c,X) can be written as the product ⱼ₌₀²(X−Gⱼ) of three linear polynomials if and only if G(c,X) can be written as the product ⱼ₌₀²(X²+GⱼX+1) of three quadratic polynomials, where GⱼεGF(p⁶) for j=0, 1, 2. In particular, this decomposition of G(c, X) is unique modulo permutation and either all Gⱼ are in GF(p²) or all Gⱼ are in GF(p³).

Proof. It follow from Definition 2.1 and a straightforward computation that G(c,X) equals X⁶−(c^{p}+c)X⁵+(c^{p+1}+c^{p}+c)X⁴−(C^{2p}+c²+2)X³+(C^{p+1}+c^{p}+c)X²−(c^{p}+c)X+1. All coefficients of G(c,X) and P(c,X) equal their own p^{th} power, so that G(c,X) and P(c,X) are in GF(p)[X]. Because ⱼ₌₀²(x²+GⱼX+1) equals

X⁶+(G₀+G₁+G₂)X⁵+(G₀G₁+G₀G₂+G_{1G}₂+3)X⁴+(2G₀+2G₁+2G₂+G₀G₁G₂)X³+(G₀G₁+G₀G₂+G₁G₂+3)X²+(G₀+G₁+G₂)X+1,

it follows that G(c,X)=ⱼ₌₀²(X2+GⱼX+1) is equivalent to G₀+G₁+G₂=−c^{p}−cεGF(p), G₀G₁+G₀G₂+G₁G₂=c^{p+1}+c^{p}+c−3εGF(p), and G₀G₁G₂=2c^{p}+2c−c^{2p}−c²−2εGF(p). That is, G₀,G₁,G₂ are the roots of P(c,X). The proof now follows from the fact that [symbol] ⱼ₌₀²(X−Gⱼ)=X³−(G₀+G₁+G₂)X²+(G₀G₁+G₀G₂+G₁G₂)X−G₀G₁G₂, Definition 2. 1, and the well known result that the roots of a third degree polynomial over GF(p) are either in GF(p²) or GF(p³).

Lemma 2.3. G(c,X)= [symbol] ⱼ₌₀²(X²+GⱼX+1) where, depending on cases I, II, and III as identified above, the following holds:

I. GⱼεGF(p) for j=1, 2, 3

II. G₀εGF(p) and GⱼεGF(p²) for j=1, 2

III. GⱼεGF(p³) for j=0, 1, 2 and G(c, X) is irreducible over GF(p).

Proof. Immediate. For completeness we present the details. It follows from [4, Lemmas 2.3.4.ii and 2.3.2.ν] that F(c^{p},hⱼ^{p})=0 for j=0,1,2, so that hⱼⁱ for j=0,1,2 and i=1,p are the roots of G(c,X), in cases I, II, and III.

In case III (i.e., F(c,X) is irreducible over GF(p²)) the hⱼ are conjugates over GF(p²), i.e., hⱼ=h_{j+1 mod 3}^{p}^{²}. It follows that h⁰ and its conjugates over GF(p) are the zeros of G(c,X) so that G(c,X) is irreducible over GF(p). Furthermore, hⱼ^{p}^{³}=hⱼ^{p}^{³}^{mod p}^{²}^{-p+1}=hⱼ⁻¹=h_{j+1 mod 3}^{p} and h_{j+1 mod 3}^{p}^{⁴}=h_{j+2 mod 3}^{-p}^{⁵}=hⱼ^{p}^{⁶}=hⱼ. Therefore (hⱼ+h_{j+1 mod 3}^{p})^{p}^{³}=hⱼ+h_{j+1 mod 3}^{p}, so that hⱼ+h_{j+1 mod 3}^{p}εGF(p³). With hⱼ·h_{j+1 mod 3}^{p}=h_{j+1 mod 3}^{p}·h_{j+1 mod 3}^{p}=1 and defining Gⱼ=−hⱼ−h_{j+1mod3}^{p}εGF(p³) for j=0, 1, 2 we find that in case III the polynomial G(c,X) factors as [symbol] ⱼ₌₀²(X²+GⱼX+1) over GF(p³)[X].

In case I we have for j=0, 1, 2 that hⱼ·hⱼ^{p}=hⱼ^{-p}·hⱼ^{p}=1 and (hⱼ+hⱼ^{p})^{p}=hⱼ^{p}+hⱼ^{p}^{²}=hⱼ^{p}+hⱼ so that hⱼ+hⱼ^{p}εGF(p) . Defining Gⱼ=−hⱼ−hⱼ^{p}εGF(p) for j =0.1, 2, we find that in case I the polynomial G(c,X) factors as [symbol] ⱼ₌₀²(X²+GⱼX+1) over GF(p)[X].

In case II we define G₀=−h₀−h₀^{p}, so that G₀εGF(p) as in case I. Furthermore, we define Gⱼ=−hⱼ−h₃₋ⱼ^{p} for j=1, 2. In this case (hⱼ+h₃₋ⱼ^{p})^{p}^{²}=hⱼ^{p}^{²}+h₃₋ⱼ^{p}^{³}=hⱼ+h₃₋ⱼ^{p} so that GⱼεGF(p²) for j=1, 2. Because furthermore hⱼ·h₃₋ⱼ^{p}=h₃₋ⱼ^{-p}·h₃₋ⱼ^{p}=1 we find that G(c,X) is the product of X²+G₀X+1εGF(p)[X] and X²+GⱼX+1εGF(p²)[X] for j=1, 2. This concludes the proof of Lemma 2.3.

Corollary 2.4. Depending on cases I, II, and III, the following holds:

I. P(c,X) has three roots in GF(p).

II. P(c,X) has one root in GF(p) and two roots in GF(p²).

III. P(c,X) has three roots in GF(p³) GF(p) .

Corollary 2.5. F(c,X) is irreducible over GF(p²) if and only if P(c,X) is irreducible over GF(p).

In the next section we show that we can determine irreducibility for P(c,X) faster than for F(c,X). Note that P(c,X) can be computed from F(c,X) at the cost of a small constant number of multiplications in GF(p).

3. Testing P(c,X) E GF(p)[X] for irreducibility

Let P(c,X) E GF(p)[X] as in Definition 2.1. We base our method to test P(c,X) for irreducibility over GF(p) on Scipione del Ferro's method, cf. [5, Algorithm 3.1]. We recall this algorithm as it applies to P(c,X) εGF(p)[X].

Algorithm 3.1. To find the roots of P(c,X)=X³+p₂X²+p₁X+p₀εGF(p)[X] in a field of characteristic unequal to 2 or 3, do the following.

1. Compute the polynomial P(c,X-p₂/3)=X³+ƒ₁X+ƒ₀εGF(p)[X] with ƒ₁=pᵢ−p₂²/3 and ƒ₀=(27p₀−9p₂p₁+2p₂³)/27.

2. Compute the discriminant Δ=ƒ₀²⁺4ƒ₁³/27εGF(p) of the polynomial X²+ƒ₀X−(ƒ₁/3)³, and compute its roots r_{1,2}=(−ƒ₀±∞\sqrt{Δ})/2.

3. If r₁=r₂=0, then let u=ν=0. Otherwise, let r₁≠0, compute a cube root u if r₁, and let ν=−ƒ₁/(3u).

4. The roots of P(c,X) are u+ν−p₂/3, uα+να²−p₂/3, and uα²+να−p₂/3, with α as in [4, Section 2. 1].

Lemma 3.2. With cases I, II, and IlI as identified in Section 2 and Algorithm 3.1 applied to the polynomial P(c,X)εGF(p)[X], we have that case III applies if and only if Δ as in Step 2 of Algorithm 3.1 is a quadratic non-residue in GF(p) and r₁ as in Step 2 ofAlgorithm 3.1 is not a cube in GF(p²).

Proof. If Δ as in Step 2 of Algorithm 3.1 is a quadratic residue in GF(p), then r₁ is in GF(p). From p≡2 mod 3 it follows that all elements of GF(p) are cubes, so u as in Step 3 of cost of 1.8 log₂ (p) multiplications in GF(p) . We now present this method in more detail.

Lemma 3.3. Let tεGF(p) be a quadratic non-residue in GF(p) and a,bεGF(p). Then a²−b²t≠0 and

$$( {( a + bX )}^{p - 1} + {( a + bX )}^{1 - p} ) mod ( {X}^{2} - t ) = 2 \frac{{a}^{2} + {b}^{2} t}{{a}^{2} - {b}^{2} t} .$$

Proof. Because t is a quadratic non-residue we find that a²−b²t≠0 and that t^{(p-1)/2}=−1. The latter implies that X^{p}=−X mod (X²−t), so that

$$( \frac{{( a + bX )}^{p}}{a + bX} + \frac{a + bX}{{( a + bX )}^{p}} ) mod ( {X}^{2} - t ) = ( \frac{a - bX}{a + bX} + \frac{a + bX}{a - bX} ) mod ( {X}^{2} - t ) .$$

The result follows with

$$\frac{a - bX}{a + bX} + \frac{a + bX}{a - bX} = \frac{{( a - bX )}^{2} + {( a + bX )}^{2}}{( a + bX ) ( a - bX )} = 2 \frac{{a}^{2} + {b}^{2} {X}^{2}}{{a}^{2} - {b}^{2} {X}^{2}} .$$

The following algorithm is well known in the context of primality testing, more specifically the p+1 -test for primality (cf. [10, Section 4]).

Algorithm 3.4. To compute the trace Tr(yⁿ)εGF(p) over GF(p) of yⁿεGF(p²), given an integer n>0 and the trace Tr(y)εGF(p) over GF(p) of some yεGF(p²) of order dividing p+1. This algorithm takes 1.8 log₂ (P) multiplications in GF(p) assuming a squaring in GF(p) takes 80% of the time of a multiplication in GF(p).

1. Let n= [symbol] ᵢ₌₀^{k}nᵢ2ⁱ with nᵢε{0,1} and nₖ≠0, let ν=Tr(y)εGF(p) and compute w=(v²−2)εGF(p).

2. For i=k−1,k−2, . . . 0 in succession, do the following.

If nᵢ=1, then first replace ν by νw−Tr(y) and next replace w by w²−2.

If nᵢ=0, then first replace w by νw−Tr(y) and next replace ν by ν²−2.

3. Return Tr(yⁿ)=ν.

Algorithm 3.5. To test P(c,X)=X³+p₂X²+p₁X+P₀εGF(p)[X] for irreducibility over GF(p), with p unequal to 2 or 3, do the following.

1. Compute the polynomial P(c,X−p₂/3)=X³+ƒ₁X+ƒ₀εGF(p)[X] with ƒ₁=p₁−p₂²/3εGF(p) and ƒ₀=(27pₚ−9p₂p₁+2p₂³)/27εGF(p).

2. Compute the discriminant Δ=ƒ₀²+4ƒ₁³/27εGF(p) of the polynomial X²ƒ₀X−(ƒ₁/3)³.

3. Compute the Jacobi symbol of Δ. If Δ is a quadratic residue in GF(p), then P(c,X) is not irreducible (cf. Lemma 3.2).

4. Otherwise, if Δ is a quadratic non-residue in GF(p), compute the trace of r₁^{p-1} over GF(p) as

$$s = 2 \frac{{f}_{0}^{2} + Δ}{{f}_{0}^{2} - Δ} ∈ GF ( p ) ,$$

where r₁=−ƒ₀/2+∞\sqrt{Δ}/2 (cf Lemma 3.3).

5. Apply Algorithm 3.4 to Tr(y)=s and n=(p+1)/3 to compute the trace over GF(p) of (r₁^{p-1})^{(p+1)/3}. If the result equals 2, then r₁ is a cube in GF(p²) and thus P(c,X) is not irreducible (cf. Lemma 3.2).

6. Otherwise, Δ is a quadratic non-residue and r₁ is not a cube in GF(p²) so that P(c,X) is irreducible over GF(p) (cf. Lemma 3.2).

Algorithm 3.1 is in GF(p) as well. It follows that P(c,X) has at least one root in GF(p) so that with Corollary 2.4 case III does not apply.

If Δ is a quadratic non-residue in GF(p), then r₁εGF(p²)\GF(p). If r₁ is a cube in GF(p²) then P(c,X) cannot have three roots in GF(p³)\GF(p) so that, with Corollary 2.4, case III does not apply. The proof now follows by observing that if Δ is a quadratic non-residue in GF(p) and r₁ is not a cube in GF(p²), then P(c,X) cannot have a root in GF(p) so that, with Corollary 2.4, case III must apply.

Lemma 3.2 reduces P(c,X)-irreducibility (and thus F(c,X)-irreducibility, cf. Corollary 2.5) to the computation of a quadratic residue symbol, possibly followed by an actual square-root computation and a cubic residuosity test. We show that the square-root computation can be avoided by combining it with the cubic residuosity test. We first sketch our approach.

In [5] it was shown Oust before Algorithm 3.5 in [5]) that an element x of GF(p²) is a cube if and only if x^{(p}^{²}^{-1)/3}=1, i.e., if and only if (x^{p-1})^{(p+1)/3}=1. It is easily shown that for yεGF(p²) of order dividing p+1 the trace over GF(p) of y^{(p+1)/3} equals 2 if and only if y^{(p+1)/3}=1. The trace over GF(p) of y^{(p+1)/3} can be computed at the cost of 1.8log₂(p) multiplications in GF(p) if the trace over GF(p) of y is known (cf. Algorithm 3.4). In our application, y=x^{p-1} and x=r₁ with r₁=−ƒ₀/2+∞\sqrt{Δ}/2 (cf. Step 2 of Algorithm 3.1) where Δ is a quadratic non-residue. We show that for x of this form the trace over GF(p) of x^{p-1} is given by an easy expression in which ∞\sqrt{Δ} does not occur. Thus, the only substantial computation that remains to be done is the computation of the trace over GF(p) of y^{(p+1)/3} at the

Theorem 3.6. For cεGF(p²) the irreducibility of the polynomial F(c,X)=X³−cX²+c^{p}X−1 over GF(p²) can be testedat the costof m+1.8 log₂(P) multiplications in GF(p),for some small constant m.

Proof. The proof follows from the result of Section 2, Algorithm 3.5, and Algorithm 3.4.

Corollary 3.7. Finding the trace of a generator of the XTR group can be expected to take about

$$\frac{q}{q - 1} ( 2.7 {log}_{2} ( p ) + 8 {log}_{2} ( ( {p}^{2} - p + 1 ) / q ) )$$

multiplications in GF(p) (cf [5, Theorem 3.7]).

Proof. Immediate from the proof of [5, Theorem 3.7] and Theorem 3.6 above. Note that the result from Corollary 3.7 is only about 2.7log₂(p) multiplications in GF(p) slower than [5, Algorithm 4.5], but more general since it applies to all p≡2 mod 3 and not only to p≡2,5 mod 9.

4. Subgroup attacks

Many cryptographic protocols can be tricked into undesirable behavior if data is used that does not have the properties prescribed by the protocol. For instance, elements of a certain group may be exchanged, but if membership of the proper group is not tested before the elements are operated upon, security may be endangered. A prominent example is the following. Let G be a cyclic, multiplicative group of prime order q (of size≧160 bits) where the discrete logarithm problem is believed to be intractable, and let g be an element of order q in G. In practice, G is often constructed as a subgroup of an abelian supergroup H, such that membership of H is easily verified.

For example, if H=GF(p)* for a 1024-bit prime number p and the set {0,1, . . . ,p−1} is used to represent GF(p) in the usual way, then xεH if and only if 0<x<p, which can trivially be tested. Similarly, if H is the group of points (written multiplicatively) of a properly chosen elliptic curve over a finite field, then xεH can simply be verified by testing that the coordinates of the ‘point’ x belong to the finite field and that x satisfies the curve equation. In both examples G may be chosen as for an element g of prime order q dividing the order |H|of H. But testing if xεG is less trivial and consists of verifying that xεH and x^{q}=1. Note that in the first example |H|/|G| is usually very large compared to q, whereas in the second example this ratio is commonly chosen to be very small.

To review why membership testing of G is crucial to maintain security we consider the Diffie-Hellman protocol. Assume that Alice calculates ν_{A}=g^{k}^{_{A}}εG where k_{A} is secret and sends the result to Bob. Likewise, Bob calculates and sends ν_{B}=g^{k}^{_{B}}εG to Alice, where k_{B} is supposed to be secret for Alice. The shared secret key g^{k}^{_{A}}^{k}^{_{B}} can then easily be computed by both Alice and Bob. The security is based on the assumption that k_{A} or k_{B} cannot be inferred from g, ν_{A}, and ν_{B}. This assumption may be incorrect if ν_{A}, or ν_{B} is replaced by an element not in G, inadvertently or on purpose. As a first illustration, suppose that αεH is of small order, say 2, and suppose that an active eavesdropper changes ν_{A} into ν_{A}·α in transit. It follows that in this scenario the Diffie-Hellman protocol runs successfully if and only if α_{B} is even (or, more in general, if the order of α divides k_{B}). In other words, the eavesdropper obtains information on k_{B}, which is not supposed to happen.

As a second illustration, suppose that |H|/|G| is a product of small primes (cf. [8]), and that h is an element of order |H|/|G|. If Alice somehow convinces Bob to use gh instead of g, and receives (gh)^{k}^{_{B}} instead of g^{k}^{_{B}}εG from Bob, then Alice can easily determine h^{k}^{_{B}} and thus k_{B} mod (|H|/|G|) by using the Pohlig-Hellman algorithm (cf. [9]). That is, Alice obtains secret information on k_{B} if Bob naively uses a ‘wrong’ generator provided by Alice and does not check subgroup membership of the results of his own computations either. Another example is the Cramer-Shoup cryptosystem (cf. [3]) whose provable resistance against chosen ciphertext attacks relies on subgroup membership for a substantial number of elements that are exchanged in the course of the protocol.

In this paper, subgroup attacks refer to attacks that take advantage of the omission to verify membership of the subgroup G: they attack the security provided by the subgroup by replacing subgroup elements by elements from the supergroup H that do not belong to the proper subgroup. Examples of subgroup and related attacks can be found in [1], [2], [6], and [11]. We implicitly assume that membership of H is verified, i.e., that all alleged elements of H are indeed elements of H, and that this verification can easily be done.

Subgroup attacks can be prevented in roughly three ways:

1. By assuring that alleged subgroup members are indeed subgroup members, i.e., performing a membership test.

2. By ensuring that the ratio |H|/|G| is small, e.g., 2.

3. By slightly adapting protocols.

We discuss these three prevention methods in more detail.

Membership test

In most practical circumstances the supergroup H is cyclic as well (as in systems based on the multiplicative group of a finite field), or the order q of G is a prime number such that H is not divisible by q² (as in elliptic curve cryptography, when using non-cyclic curve groups). The following result states that in these cases it suffices to do an order check, i.e., checking that xεH satisfies x^{q}=1, to test membership of G.

Lemma 4.1. Let G be multiplicative subgroup of prime order q of a supergroup H. If there exists an element xεH\G for which x^{q}=1, then H is not a cyclic group and the order of H is divisible by q².

Proof. Assume to the contrary that H is cyclic. Then the number of elements of order dividing q is equal to q. The set G{x}, however, contains at least q+1 elements of order dividing q; it follows that H cannot be cyclic. Furthermore, x,g is a subgroup of H of q² elements; it follows that q² divides |H|.

Thus, testing membership of G may entail an operation of cost comparable to the regular operations of the protocol. To illustrate that an order check is not sufficient in all cases, let \tilde{G} be any cyclic group of order q and consider the cyclic subgroup G=(g₁,g₂) of the supergroup H=\tilde{G}², where g₁,g₂ are randomly chosen in \tilde{G}. In this case H is not cyclic and has order q². To test membership of G it is not sufficient to check that (h₁,h₂)^{q}=(1,1), but one needs to prove that log_{g}_{₁}(h₁)=log_{g}_{₂}(h₂) which usually is computationally infeasible. This is known as an instance of the Decision Diffie-Hellman problem which usually is computationally infeasible. The latter example is not common in cryptographic applications, but simply serves as an illustration. From now on we will restrict ourselves to the situation that an order check is sufficient, i.e., H is cyclic of order not divisible by q².

Choosing a small ratio |H|/|G|

If one chooses the ratio r=|H|/|G| small then there exist only very few possibilities to perform subgroup based attacks. It seems widely accepted that at most log₂(r) secret bits are leaked if membership of H is checked but membership of G is not. In ordinary multiplicative groups r can only be small if q is very large, thereby losing the ‘short exponents’ advantage of working in a small subgroup. The computational overhead of full size exponents can, however, be reduced by using exponents that are only as long as one typically would choose the size of a subgroup of prime order q, i.e., ≧160 bits (cf. [8, Lemma 2]). Note that a small |H|/|G| ratio is common in elliptic curve cryptosystems. In XTR the supergroup H is the order p²−p+1 subgroup of GF(p⁶)*, and the XTR group G is a subgroup of order q of H. In Section 5 below it is shown how membership of H can quickly be tested. Although the possibility of small values for |H|/|G|=(p²−p+1)/q is not explicitly mentioned in [4] or [5] it can without difficulty be used in the XTR versions of common cryptographic protocols, thereby limiting the risk of XTR subgroup attacks. Note that the risk of subgroup attacks against XTR is also very limited if |H|/|G| is chosen as 3q₂ for a prime number q₂ of the same order of magnitude as q.

Slightly Adapting Protocols

By adding an additional step to protocols using subgroups it can be ensured that the alleged subgroup element is retracted into the subgroup before secret information is employed to it. We illustrate this for the Diffie-Hellman protocol, using the notation as introduced above. Instead of using g^{k}^{_{A}}^{k}^{_{B}} as the shared secret key, one uses g^{rk}_{_{A}}^{k}_{_{B}}, where r=|H|/|G|, which is computed in the following way. Upon receipt of ν_{B} from Bob, Alice calculates (ν_{B}^{r})^{k}^{_{A}} instead of μ_{B}^{k}^{_{A}}. Similarly, Bob calculates (v_{A}^{r})^{k}^{_{B}}. Note that ν_{A}^{r} is an element of G and that ν_{A}^{rk}^{_{B}}^{mod q} can only be equal to (ν_{A}^{r})^{k}^{_{B}} if ν_{A}εG. That is, performing the operations successively is crucial and, since an attacker may have chosen ν_{A}G, it is also crucial not to compute ν_{A}^{r mod q} but ν_{A}^{r} for the ‘original’ r=|H|/|G|. Since, as we assumed, the co-factor r=|H|/|G| is relatively prime with q, breaking this variant of the Diffie-Hellman protocol is as secure as the original one with a membership test incorporated into it. Many other discrete logarithm based protocols and schemes that are susceptible to subgroup attacks, like the ElGamal scheme, can be adapted in a similar fashion.

Obviously, adaptation of protocols is typically a solution only if r is smaller than the prime order q of G, because otherwise a membership test would be more efficient. For instance, in traditional Schnorr-type subgroups systems H is the multiplicative group of a large finite field GF(p), the subgroup G has substantially smaller size q, and r is often quite large: if log₂(p)=1024 and log₂(q)=160 then log₂(r)≈864. If r>q, as in this example, then the best method we are aware of to verify subgroup membership is to check that the q^{th} power of the element to be tested equals one (after one has verified, of course, that it is an element of H). Else, if r<q, then one may choose to slightly adapt the protocols used.

5. Prevention of subgroup attacks in XTR

In this section we focus on preventing subgroup attacks for XTR. Let G denote the XTR group and H the XTR supergroup of all elements of GF(p⁶)* of order >3 and dividing p²−p+1. We describe efficient ways to determine if an element in GF(p²) is the trace of an element of H. The results from the previous section, e.g. choosing |H|/|G| small and using short exponents, can then be used to obtain variants of XTR that are not susceptible to subgroups attacks.

Let d be the element of GF(p²)/GF(p) to be verified. The first method consists simply of checking that F(d,X) is irreducible over GF(p²) (cf. [4, Remark 2.3.3]), which can be done at the cost of 1.8log₂(p) plus a small constant number of multiplications in GF(p) (cf. Theorem 3.6).

Our second method is effectively free from a computational point of view because it requires only a small constant number of operations in GF(p), but it requires a small amount of additional communication. Let p,q and Tr(g) be as above and let dεGF(p²) be the element to be verified, i.e., the element that is supposedly the trace of an element, say h, of the XTR group g. Corollary 5.9 below shows that if one sends Tr(h·g) along with d(=Tr(h)), then one can efficiently verify that d corresponds to the trace of an element of the XTR supergroup H.

Definition 5.1. Let R(X),S(X)εGF(p² )[X] be two monic third-degree polynomials with non-zero constant term. If the roots of R and S are α₀,a₁,a₂ εGF(p⁶) and β₀,β₁,β₂ εGF(p⁶), respectively, then the root-product (R,S) is defined as the monic polynomial with the nine roots αᵢ·βⱼ for 0≦i,j<2.

Lemma 5.2. For R(X),S(X)εGF(p²)[X] the root-product (R,S) is a ninth-degree polynomial over GF(p²) with non-zero constant term.

Proof. Fixing R(X) and varying S(X) one finds that the coefficients of the polynomial (R,S) are symmetric polynomials in the roots, β₀,μ₁,μ₂ of S(X), and that they can be written (cf. [7]) as linear sums of elementary symmetric polynomials in β₀ ,β₂ with fixed coefficients depending on α₀,α₁,α₂. It also follows that these fixed coefficients are symmetric polynomials in the roots α₀,α₁,α₂. The values of the elementary symmetric polynomials in α₀,α₁,α₂ and β₀,β₁,β₂ are in GF(p²) because R(X),S(X)εGF(p²)[X], so that the coefficients of the polynomial (R,S) are in GF(p²). The remainder of the lemma is straightforward.

Lemma 5.3. Let R(X),S(X)εGF(p²)[X] and let β₀,β₁,β₂εGF(p⁶) be the roots of S(X). Then

(R,S)=(β₀·β₁·β₂)³R(X·β₁⁻¹)·R(Xβ₂⁻¹).

If S(X) is irreducible over GF(p²) then

(R,S)=β₀^{3(p}^{⁴}^{+p}^{²}⁺¹⁾R(X·β₀⁻¹)·R(X·β₀^{-p}^{²})·R(X·β₀^{-p}^{⁴}).

Proof. The first part result is a straightforward verification and the second part follows form the fact that the roots of S(X) are conjugate over GF(p²) if S(X) is irreducible over GF(p²).

Note that β₀·β₁·β₂ in lemma 5.3 equals the constant term of S(X). The crucial aspect of the second part of the lemma is that it describes (R,S) using only R(X) and the conjugates of the roots of S(X). That is, if we consider the representation of GF(p⁶) that follows by adjoining a root of S(X) to GF(p²), we can efficiently determine the root-product of R(X) and S(X), assuming we can efficiently determine the (p²)^{th} and (p⁴)^{th} powers of a root of S(X) in this representation.

In our application S(X) is F(c,X) where c=Tr(g) for some element g in the XTR supergroup H. That is, F(c,X) is irreducible by [4, Remark 2.3.3], and we represent GF(p⁶) as GF(p²)(g), i.e., by adjoining the root g of F(c,X) to GF(p²). Since g^{p}^{²}=g^{p-1} and g^{p}^{⁴}=g^{-p} and g^{p-1} and g^{-p} easily follow given a representation of g^{p}, in order to be able to compute the root-product (R,F(c,X)) it suffices to have a representation for g^{p} in GF(p²)(g). The following result shows how such a representation can be obtained. We abbreviate Tr(gⁱ) as cᵢ.

Proposition 5.4. Let c=Tr(g) for some element gεH. Given cₘ₋₂=Tr(g^{m-2}) Cₘ₋₁=Tr(g^{m-1}), and cₘ=Tr(g^{m}), values K,L,MεGF(p²) such that g^{m}=Kg²+Lg+M mod F(c,X) can be computed at the cost of a small constant number of operations in GF(p).

Proof. By raising g^{m}Kg²+Lg+M to the (pⁱ)^{th} power for i=0, 2, 4, and by adding the three resulting identities, we find that cₘ=Kc₂+Lc₁+Mc₀. Similarly, from g^{m-1}=Kg+L+Mg⁻¹ and g^{m-2}=K+Lg⁻¹+Mg⁻² it follows that cₘ₋₁=Kc₁+Lc₀+Mc₋₁ and Cₘ₋₂=Kc₀+Lc₋₁+Mc₋₂ respectively. This leads to the following system of equations over GF(p²):

$$( \begin{matrix}{c}_{m - 2} \\ {c}_{m - 1} \\ {c}_{m}\end{matrix} ) = ( \begin{matrix}{c}_{- 2} & {c}_{- 1} & {c}_{0} \\ {c}_{- 1} & {c}_{0} & {c}_{1} \\ {c}_{0} & {c}_{1} & {c}_{2}\end{matrix} ) \cdot ( \begin{matrix}M \\ L \\ K\end{matrix} ) .$$

Because cₘ, cₘ₋₁ and cm₂ are given and the matrix on the right hand side is invertible (cf. [4, Lemma 2.4.4]) the proof follows.

Corollary 5.5. Let c=Tr(g) for some element gεH. Given Tr(g^{p-2}), a representation of g^{p} mod F(c,X) can be computed at the cost of a small constant number of operations in GF(p).

Proof. This follows from Proposition 5.4 and the fact that cₚ=c₁^{p}=c^{p} and cₚ₋₁=cₚ^{₂}=c₁^{p}^{²}=c₁=c.

Theorem 5.6. Let R(X)εGF(p² )[X] be a monic third-degree polynomial with non-zero constant term. Let c=Tr(g) for some element gεH. Given Tr(g^{p-2}), the root-product (R(X),F(c,X)) can be computed at the cost of a small constant number of operations in GF(p).

Proof. This follows immediately from Lemma 5.3 and Corollary 5.5.

We remark that Cₚ₋₂=cₚ₊₁, as cₚ₊₁=c·cₚc^{p}·cₚ₋₁+cₚ₋₂ (cf. [4, Lemma 2.3.4.i]), cₚ=c^{p}, and cₚ₋₁=c. As the value cₚ₋₂ plays an important role it could be pre-computed and stored. The following result states that cₚ₋₂ can quickly be recovered from a single bit.

Proposition 5.7. Let c=Tr(g) for some element gεH. Then Tr(g^{p-2})=cₚ₋₂ can be computed at the cost of a square-root computation in GF(p), assuming one bit of information to resolve the square-root ambiguity.

Proof. Write cₚ₋₂=x₁α+x₂α² in the representation of GF(p²) introduced in [4, Section 2.1]. A straightforward verification shows that (cₚ₋₁−cₚ₋₂^{p})²=−3(x₁−x₂)². Combining this with the identity for (cₚ₋₂−cₚ₋₂^{p})² given in [4, Lemmas 2.4.4 and 2.4.5] (and using that cₚ₋₂=cₚ₊₁), we find that −3(x₁−x₂)²=c^{2p+2}+18c^{p+1}+4(c^{3p}+c³)−27εGF(p).

On the other hand cₚ₋₂+cₚ₋₂^{p}=−(x₁+x₂). Using that cₚ₋₂=g^{p-2}+g^{(p-2)p}^{²}+g^{(p-2)p}^{⁴}=g^{p-2}+g^{-2p+1}+g^{p+1}, it follows that cₚ₋₂^{p}=g^{-p-1}+g^{-p+2}+g^{2p-1}=.

Now,

c^{p+1}=c·c^{p}=(g+g^{p-1}+g^{-p})(g^{p}+g⁻¹+g^{-p+1})

c^{p+1}=g^{p+1}+g^{p-2}+g^{-2p+1}+g^{-p-1}+g^{-p+2}+g^{2p-1}+3

c^{p+1}=cₚ₋₂+cₚ₋₂^{p}+3.

That is x₁+x₂=3−c^{p+1}εGF(p) . Combining the two identities involving x₁−x₂ and x₁+x₂ it follows that cₚ₋₂ and its conjugate over GF(p) can be computed at the cost of a square-root calculation in GF(p). To distinguish cₚ₋₂=x_{1α+x}₂α² from its conjugate x₂α+x₁α² a single bit that is on if and only if x₁>x₂ suffices.

Lemma 5.8. Let c=Tr(g) for some element gεH and let d,d′εGF(p²). Given the value Cₚ₋₂ the correctness of the following statement can be checked at the cost of a small, constant number of operations in GF(p): there exists an element hεH such that d=Tr(h) and d′=Tr(h·g).

Proof. Consider the following algorithm:

1. By a simple verification check whether 1, α or α² are roots of the polynomial F(d,X). If so, then the statement is not true.

2. Otherwise, calculate the root-product (F(d,X),F(c,X)) and determine if this is divisible by the polynomial F(d′,X). If so, the statement is true, otherwise it is not.

The conclusion of the first step of the algorithm is trivial. For a proof of the conclusion of Step 2 of the algorithm, assume that d is not equal to the trace of an element of H. It follows from [4, Lemma 2.3.2] that the roots of F(d,X) are in GF(p²) . According to Step 1 the roots are not equal to 1, α or α², so that the roots of F(d,X) are not members of H either, as the greatest common divisor of p²p+1 and p²−1 is 3 and H has order >3. It easily follows that none of the roots of the root-product (F(d,X),F(c,X)) lies in H. Moreover, as the roots of F(c,X) do not lie in GF(p²), it follows that the roots of the root-product do not lie in GF(p²) either.

Applying [4, Lemma 2.3.2] once more, the roots of the polynomial F(d′,X) are either in GF(p²) or in H. It follows that F(d′,X) cannot divide the root-product (F(d,X),F(c,X)) . Thus if F(d′,X) divides (F(d,X),F(c,X)), then d is equal to the trace of an element hεH. In this situation, the roots of the root-product are equal to h^{p}^{ⁱ}·g^{p}^{^{j}} for i,j=0, 2, 4. It follows that F(d′,h^{p}^{ⁱ}·g)=0 for some i in {0, 2, 4} and hence that d =Tr(h^{p}^{ⁱ}) and d′=Tr(h^{p}^{ⁱ}·g). That is, the statement is true.

We finally observe that the algorithm requires a small constant number of operations in GF(p²).

Corollary 5.9. Let c=Tr(g) for some element gεH and suppose that Tr(g^{p-2}) is known. Then accompanying the trace value of an element hεH by the trace of its ‘successor’ h·g enables an efficient proof of membership of h in H.

Corollary 5.10. Let c=Tr(g) where g is (known to be) a generator of the XTR group, let d be the trace of an element that is (known to be) in the XTR group g, and let d' be some element of GF(p²). Then it can efficiently be verified if d and d′are of the form Tr(g^{x}), Tr(g^{x+1}), respectively, for some integer x, 0<x<q.

An XTR public key meant for digital signatures takes the form p, q, c, d, and d' where p and q are primes satisfying the usual XTR conditions and where c =Tr(g) for a generator g of the XTR group, d=Tr(g^{k}) for a secret key k, and d′=Tr(g^{k+1}) (cf. [4]). The above corollary implies that a Certificate Authority can efficiently verify the consistency of an XTR signature public key presented by a client, before issuing a certificate on it. More specifically, suppose a client provides a Certificate Authority with XTR public key data containing p, q, c, d, and d′ where p and q are primes satisfying the usual XTR conditions and where, supposedly, c=Tr(g) for a generator g of the XTR group, d=Tr(g^{k}) for a secret key k, and d′=Tr(g^{k+1}). The Certificate Authority can easily check that this is indeed the case, in two steps. First, the Certificate Authority checks that p and q are well-formed and that c and d are indeed traces of elements of the XTR group using standard XTR arithmetic (cf. [4, Lemma 2.3.4 and Theorem 2.3.8]). Secondly, the Certificate Authority uses Corollary 5.10 to verify that d and d′ are traces of consecutive (and unknown, to the Certificate Authority) powers of the generator corresponding to c.

References

1. I. Biehl, B. Meyer, V. Müiller, Differentialfault attacks on elliptic curve cryptosystems, Proceedings of Crypto 2000, LNCS 1880, Springer-Verlag, 2000, 131-146.

2. M. V. D. Burmester, A remark on the efficiency of identification schemes, Proceedings of Eurocrypt '90, LNCS 473, Springer-Verlag 1990, 493-495.

3. R. Cramer, V. Shoup, A practical public key cryptosystem provably secure against adaptive chosen ciphertext attack, Proceedings of Crypto '98, LNCS 1462, Springer-Verlag 1998, 13-25.

4. A. K. Lenstra, E. R. Verheul, The XTR public key system, Proceedings of Crypto 2000, LNCS 1808, Springer-Verlag, 2000,1-19; available from www.ecstr.com.

5. A. K. Lenstra, E. R., Verheul, Key improvements to XTR, Proceedings of Asiacrypt 2000, LNCS 1976, Springer-Verlag, 2000, 220-233; available from www.ecstr.com.

6. C. H. Lim, P. J. Lee, A key recovery attack on discrete log-based schemes using a prime order subgroup, Proceedings of Crypto '97, LNCS 1294, Springer-Verlag 1997, 249-263.

7. W. K. Nicholson, Introduction to abstract algebra, PWS-Kent Publishing Company, Boston, 1993.

8. P. C. van Oorschot, M. J. Wiener, On Diffie-Hellman key agreement with short exponents, Proceedings of Eurocrypt '96, LNCS 1070, Springer-Verlag 1996, 332-343.

9. S. C. Pohlig, M. E. Hellman, An improved algorithm for computing logarithms over GF(p) and its cryptographic significance, IEEE Trans. on IT, 24 (1978), 106-110.

10. H. Riesel, Prime numbers and computer methods for factorization, Birkhäuser, Boston, 1985.

11. E. R. Verheul, M. P. Hoyle, Tricking the Chaum-Pedersen protocol, manuscript, 1998.

Although the embodiments disclosed herein describe a fully functioning system, method, and computer program product that improves the efficiency of the polynomial irreducibility test and the subgroup membership test in an XTR system, the reader should understand that other equivalent embodiments exist. Since numerous modifications and variations will occur to those who review this disclosure, the system, method, and apparatus that improves the efficiency of the polynomial irreducibility test and the subgroup membership test in an XTR system is not limited to the exact construction and operation illustrated and disclosed herein. Accordingly, this disclosure intends all suitable modifications and equivalents to fall within the scope of the claims.

We claim:

1. A method of parameter setup in a cryptosystem that implements XTR, comprising:
finding a trace of a generator of a group; and
initializing the cryptosystem with the trace.

2. The method of claim 1, further comprising:
testing a subgroup membership with the cryptosystem.

3. A method of parameter setup in a cryptosystem that implements XTR, comprising:
reformulating an irreducibility test of a polynomial of the form F(c,X)=X³−cX²+C^{p}X−1εGF(p²)[X], for random cεGF(p²), as an irreducibility problem for a third-degree polynomial of the form P(c,X)=X³+(c^{p}+c)X²+(c^{p+1}+c^{p}+c−3)X+c^{2p}+c²+2−2c^{p}−2c; and
testing the third-degree polynomial of the form P(c,X)=X³+(c^{p}+c)X²+(C^{p+1}+c^{p}+c−3)X+c^{2p}+c²+2−2c^{p}−2c for irreducibility over GF(p).

4. The method of claim 3, wherein the testing of the third-degree polynomial fuirther comprises:
eliminating the coefficient of X² from P(c,X) by substituting X−(c^{p}+c)/3 for X and generating the polynomial P(c,X−(c^{p}+c)/3)=X³+ƒ₁X+ƒ₀; and
computing a discriminant Δ=ƒ₀²+4ƒ₁³/27εGF(p) by considering a polynomial of the form X²+ƒ₀X−(ƒ₁/3)³;
wherein, if Δ is a quadratic residue in GF(p), P(c,X) is not irreducible over GF(p).

5. The method of claim 4, wherein, if Δ is not a quadratic residue in GF(p), the method further comprises:
computing a trace over GF(p) of r₁^{p-1} as
$$s = 2 \frac{{f}_{0}^{2} + Δ}{{f}_{0}^{2} - Δ} ,$$
wherein r₁=−ƒ₀/2+∞\sqrt{Δ}/2; and
computing a trace z over GF(p) of (r₁^{p-1})^{(p+1)/3};
wherein, if the trace z is 2, P(c,X) is not irreducible over GF(p).

6. The method of claim 5, wherein, if the trace z is not 2, P(c,X) is irreducible over GF(p).

7. The method of claim 3, fuirther comprising:
preventing a subgroup attack on the cryptosystem.

8. The method of claim 7, wherein the preventing of the subgroup attack futrther comprises:
verifying the consistency of an XTR signature public key presented by a client before issuing a certificate to prevent the subgroup attack on the cryptosystem.

9. A system of parameter setup in a cryptosystem that implements XTR, comprising:
means for finding a trace of a generator of a group; and means for initializing the cryptosystem with the trace.

10. The system of claim 9, further comprising:
means for testing a subgroup membership when using the cryptosystem.

11. A system of parameter setup in a cryptosystem that implements XTR, comprising:
a memory device; and
a processor disposed in communication with said memory device, said processor configured to:
reformulate an irreducibility test of a polynomial of the form F(c,X)=X³−cX²+c^{p}X−1εGF(p²)[X], for random cεGF(p²), as an irreducibility problem for a third-degree polynomial of the form P(c,X)=X³+(c^{p}+c)X²+(c^{p+1}+c^{p}+c−3)X+c^{2p}+c²+2−2c^{p}−2c; and
test the third-degree polynomial of the form P(c,X)=X³+(c^{p}+c)X²+(c^{p+1}+c^{p}+c−3)X+c^{2p}+c²+2−2c^{p}−2c for irreducibility over GF(p).

12. The system of claim 11, wherein to test the third-degree polynomial, said processor is further configured to:
eliminate the coefficient of X² from P(c,X) by substituting X−(c^{p}+c)/3 for X and generating the polynomial P(c,X−(c^{p}+c)/3)=X³+ƒ₁X+ƒ₀; and compute a discriminant Δ=ƒ₀²+4ƒ₁³/27εGF(p) by considering a polynomial of the form X²+ƒ₀X−(ƒ₁/3)³;
wherein, if Δ is a quadratic residue in GF(p), P(c,X) is not irreducible over GF(p).

13. The system of claim 12, wherein, if Δ is not a quadratic residue in GF(p), said processor is further configured to:
compute atrace over GF(p) of r₁^{p-1} as
$$s = 2 \frac{{f}_{0}^{2} + Δ}{{f}_{0}^{2} - Δ} ,$$
wherein r₁=−ƒ₀/2+∞\sqrt{Δ}/2; and
compute a trace z over GF(p) of (r₁^{p-1})^{(p+1)/3};
wherein, if the trace z is 2, P(c,X) is not irreducible over GF(p).

14. The system of claim 13, wherein, if the trace z is not 2, P(c,X) is irreducible over GF(p) .

15. The system of claim 11, wherein said processor is flurther configured to:
prevent a subgroup att ack on the cryptosystem.

16. The system of claim 15, wherein to prevent the subgroup attack said processor is firther configured to:
verify the consistency of an XTR signature public key presented by a client before issuing a certificate to prevent the subgroup attack on the cryptosystem.

17. A computer program product for parameter setup in a crypto system that implements XTR, comprising:
a computer readable medium;
program code in said computer readable medium for finding a trace of a generator of a group; and
program code in said computer readable medium for initializing the cryptosystem with the trace.

18. The computer program product of claim 17, further comprises:
program code in said computer readable medium for testing a subgroup membership when using the cryptosystem.

19. A computer program product for parameter setup in a cryptosystem that implements XTR, comprising:
a computer readable medium;
program code in said computer readable medium for reformulating an irreducibility test of a polynomial ofthe form F(c,X)=X³−cX²+c^{p}X−1εGF(p²)[X], forrandom cεGF(p²), as an irreducibility problem for a third-degree polynomial of the form P(c,X)=X³+(c^{p}+c)X²+(c^{p+1}+c^{p}+c−3)X+c^{2p}+c²+2−2c^{p}−2c; and
program code in said computer readable medium for testing the third-degree polynomial of the form P(c,X)=X³+(c^{p}+c)X²+(c^{p+1}+c^{p}+c−3)X+c^{2p}+c²+2−2c^{p}−2c for irreducibility over GF(p) .

20. The computer program product of claim 19, wherein the testing of the third-degree polynomial fuirther comprises:
program code in said computer readable medium for eliminating the coefficient of X² from P(c,X) by substituting X−(c^{p}+c)/3 for X and generating the polynomial P(c,X−(c^{p}+c)/3)=X³+ƒ₁X+ƒ₀; and
program code in said computer readable medium for computing a discriminant Δ=ƒ₀²+4ƒ₁³/27εGF(p) by considering a polynomial of the form X²+ƒ₀X−(ƒ₁/3)³;
wherein, if Δ is a quadratic residue in GF(p), P(c,X) is not irreducible over GF(p) .

21. The computer program product of claim 20, wherein, if Δ is not a quadratic residue in GF(p), the computer program product flrher comprises:
program code in said computer readable medium for computing a trace over GF(p) of r₁^{p-1} as
$$s = 2 \frac{{f}_{0}^{2} + Δ}{{f}_{0}^{2} - Δ} ,$$
wherein r₁=−ƒ₀/2+∞\sqrt{Δ}/2; and program code in said computer readable medium for computing a trace z over GF(p) of (r₁^{p-1})^{(p+1)/3};
wherein, if the trace z is 2, P(c,X) is not irreducible over GF(p) .

22. The computer program product of claim 21, wherein, if the trace z is not 2, P(c,X) is irreducible over GF(p).

23. The computer program product of claim 19, flurther comprising:
program code in said computer readable medium for preventing a subgroup attack on the cryptosystem.

24. The computer program product of claim 23, further comprising:
program code in said computer readable medium for verifying the consistency of an XTR signature public key presented by a client before issuing a certificate to prevent the subgroup attack on the cryptosystem.
